(19) United States
(12) Patent Application Publication
(10) Pub. No.: US 2016/0102492 A1
(43) Pub. Date: Apr. 14, 2016

(54) INTEGRAL PLASTIC TRUE DIVIDED LIGHT WINDOW FRAME

(71) Applicant: MaxCraft Doors, Inc., Duluth, GA (US)

(72) Inventor: Zhihua Cai, Suwanee, GA (US)

(21) Appl. No.: 14/879,890

(22) Filed: Oct. 9, 2015

Related U.S. Application Data
(60) Provisional application No. 62/062,412, filed on Oct. 10, 2014.

(51) Int. Cl. E06B 3/54; E06B 3/663; E06B 3/964; E06B 3/64; E06B 3/68

(52) U.S. Cl. CPC E06B 3/5481; E06B 3/64; E06B 3/68; E06B 3/964; E06B 3/66304; E06B 3/66309

(57) ABSTRACT

An integral plastic true divide light (TDL) window frame to replace wood true divided light window frame and grilles which are composed of individual pieces of wood frames and grilles joined together chemically or mechanically. The integral plastic TDL window frame is preferably of one-piece molded plastic construction with a number of small windows for holding individual panes of insulating glass units (lights, preferably with beveled glass), and consequently the window frame and muntin grilles form an inseparable integrated unit.

### CROSS REFERENCE TO RELATED APPLICATION

This application claims the benefit of U.S. Provisional Application No. 62/062,412 filed Oct. 10, 2014, which is incorporated by reference.

### FIELD OF THE INVENTION

The invention relates to multiple-pane sealed glazing units and more particularly to window frames with beveled glass to resemble the same appearance of traditional true divided light (TDL) windows with wood frames and grilles.

### BACKGROUND OF THE INVENTION

Large pieces of glass used to be expensive to manufacture, so windows were made up of several pieces put into frames. These were true divided light (TDL) windows. As glassmaking technology improved in the 20th century and energy efficiency became a consideration—marked by the arrival of insulated glass—the one-piece window became popular. Then the pendulum swung back again about 25 years ago. People wanted to see more of that more traditional look and started manufacturing true divided-light windows with insulated glass because they wanted to keep the advantages of insulation but put it in the structure of the true divided light grille, especially in exterior door applications. Wood TDL windows are very labor intensive to produce as individual pieces of wood frames and grilles will have to be joined together chemically or mechanically by hand. Besides, TDL light windows are still limited to those with wood frames and grilles. As fiberglass doors, especially these with wood grains, are gaining bigger and bigger market share, these is a strong demand for fiberglass doors with TDL beveled glass windows.

A contemporary alternative to true divided light is simulated divided light (SDL) as disclosed in U.S. Pat. No. 4,598,520, U.S. Pat. No. 4,783,938 and U.S. Pat. No. 5,345,743. But none of them has incorporated beveled glass in the designs. Therefore, these SDL glass designs lack the elegance of TDL windows with beveled glass.

Therefore, an objective of the present invention is to provide a TDL window assembly that is easier to manufacture and assemble.

Another objective of the present invention is to provide a TDL window assembly made of plastic.

A still further objective of the present invention is to provide a TDL window assembly having beveled glass.

These and other objectives will be apparent to those skilled in the art based upon the following written description, drawings and claims.

### SUMMARY OF THE INVENTION

The present invention provides an integral plastic TDL window frame assembly that is suitable for mass production at low cost. The integral TDL window frame is preferably of one-piece injection molded unit including both an outer frame portion and an inner grille portion. The integral plastic true divided light window frame assembly may be made of injection-molded thermoplastic or compression molded thermosetting plastic/fiberglass. Different sizes and styles are made through the use of different molds. Two sets of frames, interior frame and exterior frame, are needed for a true divided light window unit. The outer frame portion and inner grille (glass divider/stiffener) portion form a number (typically 2, 3, 4, 5, 6, 8, 9, 10, 12 and 15) of small windows. The individual pieces of beveled insulating glass units (lights) are each put into one of the small windows and caulked to one of the frames, usually the exterior frame. Then the TDL window unit is put into the opening of the door and mounted/held on to the door by screwing the interior frame to the exterior frame.

An alternative to make plastic TDL window frame is that the window frame is composed of individual pieces of plastic frames and grilles which are joined together chemically or mechanically by hand. This is more labor intensive but reduces the initial investment on molds.

### BRIEF DESCRIPTION OF THE DRAWINGS

FIG. 1 is a front view of an integral plastic TDL window frame with beveled glass assembly;

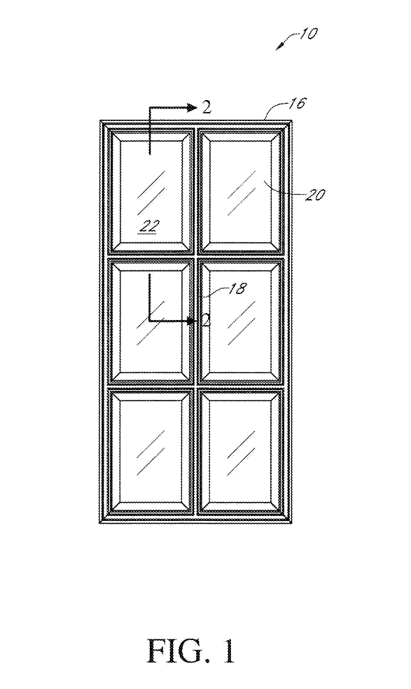

FIG. 2 is a cross section view taken along line A-A in FIG. 1;

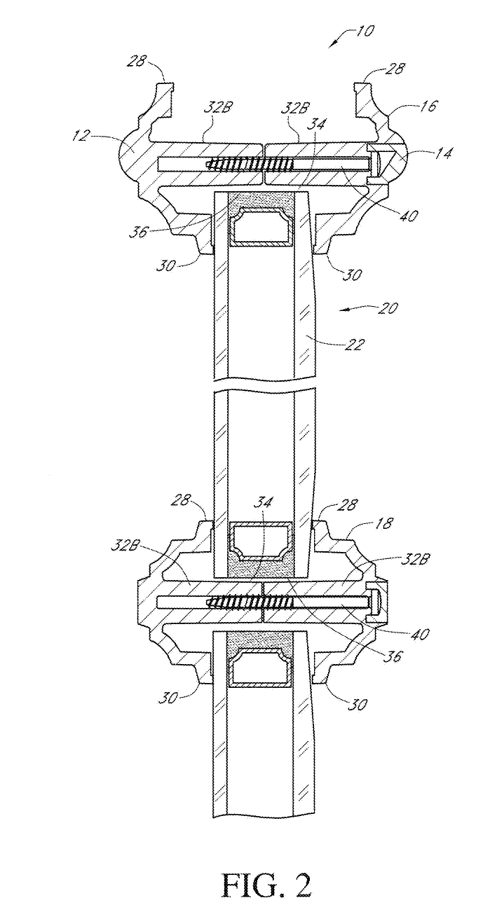

FIG. 3 is an exploded oblique view showing the components of the integral plastic TDL window frame with beveled glass assembly; and

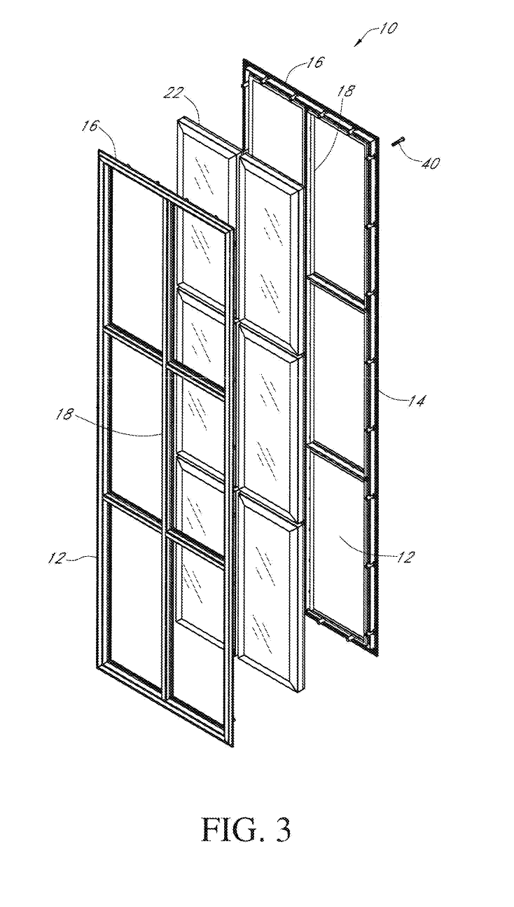

FIG. 4 is an exploded perspective view of an integral plastic TDL window assembly.

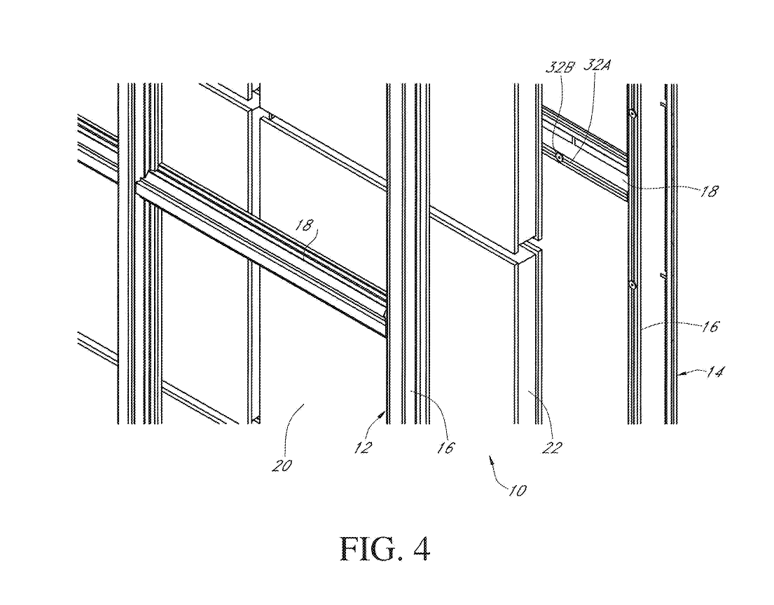

### DETAILED DESCRIPTION OF THE PREFERRED EMBODIMENT

Referring to the figures, a TDL window assembly 10 has an exterior frame 12 and an interior frame 14. Both the exterior 12 and interior 14 frames have an outer frame portion 16 and an interior grill portion 18. The outer frame portion 16 and inner grill portion 18 form a plurality of small windows or light openings 20 configured to receive a glass unit 22. Individual glass units 22 are inserted into one of the windows 20 and caulked to one of the frames 12 or 14 and preferably the exterior frame 12. Each glass unit 22 preferably includes a pair of glass panes 24, with at least one pane 24 beveled that are in spaced parallel relation and separated by a spacer 26.

The outer frame portion 16 and the inner grill portion 18 have outwardly extending flanges 28 and an inwardly extending flanges 30. Between the flanges 28 and 30 extending transversely toward the opposite frame is a glass stop 32. The glass stops 32 are positioned to prevent the glass units 22 from moving freely. A space 34 between the edge 36 of the glass unit 22 and the glass stop 32 is provided and preferably the space is 1/16 inches.

The glass stops 32 are of any size, shape, type and style. For example, the glass stops 32 can be continuous or non-continuous double walled muntin bars 32A, or screw bores 32B, or a combination of both. Also, the glass stops 32 are integral with the frames 12 and 14 or an add-on component.

Preferably, the exterior 12 and interior 14 frames are of a one-piece injection molded thermoplastic construction or compression molded thermosetting plastic/fiberglass construction. Alternatively, the frames 12 and 14 are made using individually molded plastic frames and grills which are joined together chemically or mechanically.

Once the window is assembled, the assembly is placed in a door or window 38 opening and mounted to the opening by screwing the interior frame 14 to the exterior frame 12 with a screw 40 such that the door or window is held between flanges 28 of the outer frame portion 16 of the exterior 12 and interior 14 frames.

Accordingly, a TDL window assembly has been disclosed that at the very least meets the stated objectives.

What is claimed is:

1. A true divided light window assembly, comprising:
an interior frame and exterior frame having outer frame portions and interior grill portions that form a plurality of window openings; and
a plurality of glass units having a plurality of glass panes positioned within the plurality of window openings and adhered to at least one of the frames.

2. The assembly of claim 1 wherein the plurality of glass units include a pair of glass panes separated by a spacer in parallel spaced relation.

3. The assembly of claim 2 wherein at least one of the pair of glass panes is beveled.

4. The assembly of claim 1 wherein the interior and exterior frames have glass stops that extend transverse to the frames toward one another.

5. The assembly of claim 4 wherein the glass stops are continuous muntin bars.

6. The assembly of claim 4 wherein the glass stops are non-continuous muntin bars.

7. The assembly of claim 4 wherein the glass stops are continuous screw bores.

8. The assembly of claim 4 wherein the glass stops are non-continuous screw bores.

9. The assembly of claim 4 wherein the glass stops are attached to the frames as an add-on.

10. The assembly of claim 1 wherein the interior and exterior frames are of a one-piece injection molded thermoplastic construction.

11. The assembly of claim 1 wherein the interior and exterior frames are of a compression molded thermosetting plastic construction.

12. The assembly of claim 1 wherein the interior and exterior frames are made of individually molded plastic frames and grills that are joined together.
